(19) United States
(12) Patent Application Publication
(10) Pub. No.: US 2022/0057218 A1
(43) Pub. Date: Feb. 24, 2022

(54) METHOD AND APPARATUS FOR AUTOMATIC GENERATION OF CONTEXT-BASED GUIDANCE INFORMATION FROM BEHAVIOR AND CONTEXT-BASED MACHINE LEARNING MODELS

(71) Applicant: HERE Global B.V., Eindhoven (NL)

(72) Inventor: Arun BALAKRISHNA, Frankfurt (DE)

(21) Appl. No.: 17/112,300

(22) Filed: Dec. 4, 2020

Related U.S. Application Data
(60) Provisional application No. 63/067,603, filed on Aug. 19, 2020.

(51) Int. Cl. G01C 21/34; G01C 21/36; G06N 20/00; G06K 9/62

(52) U.S. Cl. CPC G01C 21/3415; G06K 9/6256; G06N 20/00; G01C 21/3655

(57) ABSTRACT

A method, apparatus and computer program product are provided for generating guidance information based on a cognitive load of a user and presenting the guidance information in a manner dependent upon the cognitive load. In context of a method, the method receives a plurality of user data associated with a user and determines relationship data for the plurality of user data utilizing one or more machine learning models. The method also determines a cognitive load of the user based on the relationship data and generates contextual guidance information configured to be presented to the user in a manner dependent upon the cognitive load. The method also causes presentation of the contextual guidance information to the user.

### CROSS-REFERENCE TO RELATED APPLICATIONS

This application claims the benefit of U.S. Provisional Patent Application No. 63/067,603, filed Aug. 19, 2020, the entire contents of which are incorporated herein by reference.

### TECHNOLOGICAL FIELD

An example embodiment relates generally to a method, apparatus and computer program product for generating guidance information and, more particularly, for generating guidance information based on a cognitive load of a user and presenting the guidance information in a manner dependent upon the cognitive load.

### BACKGROUND

Guidance information may be provided to a vehicle and/or driver for navigation purposes. For example, guidance information may include instructions for maneuvering the vehicle in order to arrive at an intended destination. However, due to the static nature of guidance information, it may be difficult for a driver to decipher and/or adhere to instructions provided by guidance information in an instance in which additional factors are impacting the environment of the vehicle and/or driver.

### BRIEF SUMMARY

A method, apparatus and computer program product are therefore provided in accordance with an example embodiment for generating and providing guidance information based on a current cognitive load of a user. By utilizing one or more machine learning models, such as behavior and context-based machine learning models, as well as data from a map database, traffic source(s), and/or road authority source(s), context-appropriate guidance information may be generated and provided to a user, thereby leading to increased passenger safety, reduced network load by way of an increased adherence to guidance information, and an overall improved passenger experience.

In an example embodiment, an apparatus is provided that includes at least one processor and at least one memory storing computer program code, with the at least one memory and the computer program code configured to, with the processor, cause the apparatus to at least receive a plurality of user data associated with a user. The at least one memory and the computer program code are also configured to, with the processor, cause the apparatus to determine, utilizing one or more machine learning models, relationship data comprising one or more relationships between attributes of the plurality of user data. The at least one memory and the computer program code are also configured to, with the processor, cause the apparatus to determine, based at least on the relationship data, a cognitive load of the user. The at least one memory and the computer program code are also configured to, with the processor, cause the apparatus to generate contextual guidance information configured to be presented to the user in a manner dependent upon the cognitive load of the user. The at least one memory and the computer program code are also configured to, with the processor, cause the apparatus to cause presentation of the contextual guidance information to the user.

The at least one memory and the computer program code of an example embodiment are further configured to, with the processor, cause the apparatus to receive user feedback of the contextual guidance information. The at least one memory and the computer program code of an example embodiment are further configured to, with the processor, cause the apparatus to update the one or more machine learning models based at least on the user feedback.

The at least one memory and the computer program code of an example embodiment that are further configured to update the one or more machine learning models are further configured to, with the processor, cause the apparatus to reconfigure the contextual guidance information based on the updating of the one or more machine learning models.

The at least one memory and the computer program code of an example embodiment configured to determine the cognitive load of the user are further configured to, with the processor, cause the apparatus to apply one or more predefined rules to the relationship data. The one or more predefined rules are associated with a human cognitive model.

The at least one memory and the computer program code of an example embodiment configured to determine the cognitive load of the user are further configured to, with the processor, cause the apparatus to calculate information gain for the one or more relationships between attributes of the plurality of user data.

In some embodiments of the apparatus, the plurality of user data comprises data associated with one or more user devices associated with the user and sensor data associated with one or more sensors of a vehicle associated with the user.

In some embodiments of the apparatus, at least one of the one or more machine learning models are trained in accordance with one or more of: historical map data, historical user behavioral data, historical user context data, external road authority source data, or external traffic source data.

In an example embodiment, an apparatus is provided that includes means for receiving a plurality of user data associated with a user. The apparatus also includes means for determining, utilizing one or more machine learning models, relationship data comprising one or more relationships between attributes of the plurality of user data. The apparatus also includes means for determining, based at least on the relationship data, a cognitive load of the user. The apparatus also includes means for generating contextual guidance information configured to be presented to the user in a manner dependent upon the cognitive load of the user. The apparatus also includes means for causing presentation of the contextual guidance information to the user.

The apparatus of an example embodiment further includes means for receiving user feedback of the contextual guidance information. The apparatus of an example embodiment further includes means for updating the one or more machine learning models based at least on the user feedback.

The apparatus of an example embodiment further includes means for updating the one or more machine learning models so as to reconfigure the contextual guidance information based thereupon.

The apparatus of an example embodiment including means for determining the cognitive load of the user further includes means for applying one or more predefined rules to the relationship data. The one or more predefined rules are associated with a human cognitive model.

The apparatus of an example embodiment including means for determining the cognitive load of the user further includes means for calculating information gain for the one or more relationships between attributes of the plurality of user data.

In some embodiments of the apparatus, the plurality of user data comprises data associated with one or more user devices associated with the user and sensor data associated with one or more sensors of a vehicle associated with the user.

In some embodiments of the apparatus, at least one of the one or more machine learning models are trained in accordance with one or more of: historical map data, historical user behavioral data, historical user context data, external road authority source data, or external traffic source data.

In a further example embodiment, a method is provided. The method includes receiving a plurality of user data associated with a user. The method also includes determining, utilizing one or more machine learning models, relationship data comprising one or more relationships between attributes of the plurality of user data. The method also includes determining, based at least on the relationship data, a cognitive load of the user. The method also includes generating contextual guidance information configured to be presented to the user in a manner dependent upon the cognitive load of the user. The method also includes causing presentation of the contextual guidance information to the user.

The method of an example embodiment further includes receiving user feedback of the contextual guidance information. The method of an example embodiment further includes updating the one or more machine learning models based at least on the user feedback.

In some embodiments of the method, updating the one or more machine learning models further includes reconfiguring the contextual guidance information based on the updating of the one or more machine learning models.

In some embodiments of the method, determining the cognitive load of the user further includes applying one or more predefined rules to the relationship data. The one or more predefined rules are associated with a human cognitive model.

In some embodiments of the method, determining the cognitive load of the user further includes calculating information gain for the one or more relationships between attributes of the plurality of user data.

In some embodiments of the method, the plurality of user data comprises data associated with one or more user devices associated with the user and sensor data associated with one or more sensors of a vehicle associated with the user.

In some embodiments of the method, at least one of the one or more machine learning models are trained in accordance with one or more of: historical map data, historical user behavioral data, historical user context data, external road authority source data, or external traffic source data.

In an example embodiment, a computer program product is provided that includes a non-transitory computer readable medium having program code portions stored thereon with the program code portions being configured, upon execution, to receive a plurality of user data associated with a user. The program code portions are also configured to determine, utilizing one or more machine learning models, relationship data comprising one or more relationships between attributes of the plurality of user data. The program code portions are also configured to determine, based at least on the relationship data, a cognitive load of the user. The program code portions are also configured to generate contextual guidance information configured to be presented to the user in a manner dependent upon the cognitive load of the user. The program code portions are also configured to cause presentation of the contextual guidance information to the user.

The program code portions of an example embodiment are further configured to receive user feedback of the contextual guidance information. The program code portions of an example embodiment are further configured to update the one or more machine learning models based at least on the user feedback.

The program code portions of an example embodiment that are further configured to update the one or more machine learning models are further configured to reconfigure the contextual guidance information based on the updating of the one or more machine learning models.

The program code portions of an example embodiment that are configured to determine the cognitive load of the user are further configured to apply one or more predefined rules to the relationship data. The one or more predefined rules are associated with a human cognitive model.

The program code portions of an example embodiment that are configured to determine the cognitive load of the user are further configured to calculate information gain for the one or more relationships between attributes of the plurality of user data.

In some embodiments of the computer program product, the plurality of user data comprises data associated with one or more user devices associated with the user and sensor data associated with one or more sensors of a vehicle associated with the user.

In some embodiments of the computer program product, at least one of the one or more machine learning models are trained in accordance with one or more of: historical map data, historical user behavioral data, historical user context data, external road authority source data, or external traffic source data.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of an example system including the apparatus of FIG. 1 that may be specifically configured in accordance with an example embodiment;

FIG. 3 is a flowchart illustrating the operations performed, such as by the apparatus of FIG. 1, in order to generate contextual guidance information in accordance with an example embodiment; and

FIG. 4 is a flowchart illustrating the operations performed, such as by the apparatus of FIG. 1, in order to reconfigure contextual guidance information based on user feedback in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As described above, guidance information that is provided to a vehicle and/or user (e.g., a driver/passenger occupying the vehicle) may be static. For example, static guidance information may direct a driver of a vehicle to “turn left in 100 feet” by visually displaying text indicating such at a user interface. However, such static guidance information fails to consider both how to best inform the driver and how to present the information based on current conditions the driver may be experiencing. In this regard, the visual display of instructional text given in the above example may be insufficient in an instance in which the driver is experiencing certain conditions, such as heavy rainfall and/or low visibility. In this regard, the driver may be experiencing a high cognitive load, and taking their eyes off of the road to view the instructions at the user interface may be unsafe, and further, estimating 100 feet in order to make the left turn may be difficult for the driver due to the heavy rainfall.

A method, apparatus and computer program product are provided in accordance with an example embodiment in order to generate contextual guidance information configured to be presented to a user in a manner dependent upon a cognitive load of the user. In this regard, one or more machine learning models may be utilized to process a plurality of data associated with a driver and/or vehicle in order to determine and present contextual guidance information to the driver in an optimal manner such that the driver can process the guidance information and execute instructions provided by the guidance information given the driver's current cognitive load.

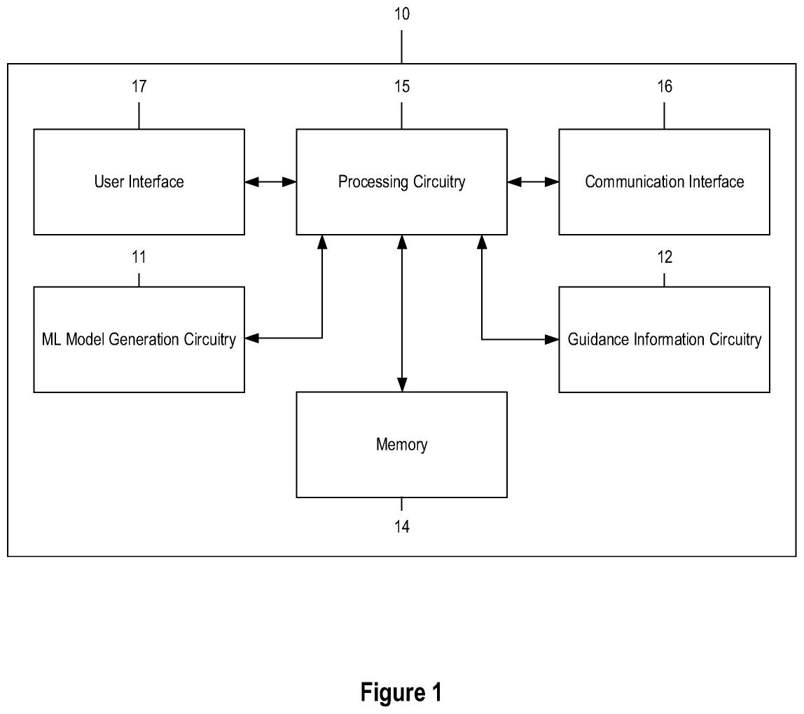

Referring now to FIG. 1, the apparatus 10 that is configured to generate and provide contextual guidance information may be any of a wide variety of computing devices. For example, the apparatus may be embodied by a server, a computer workstation, a distributed network of computing devices, a personal computer, a navigation or mapping system, an advanced driver-assistance system (ADAS) or any other type of computing device including mobile computing devices, such as a mobile telephone, personal computer, tablet computer, personal navigation device or the like.

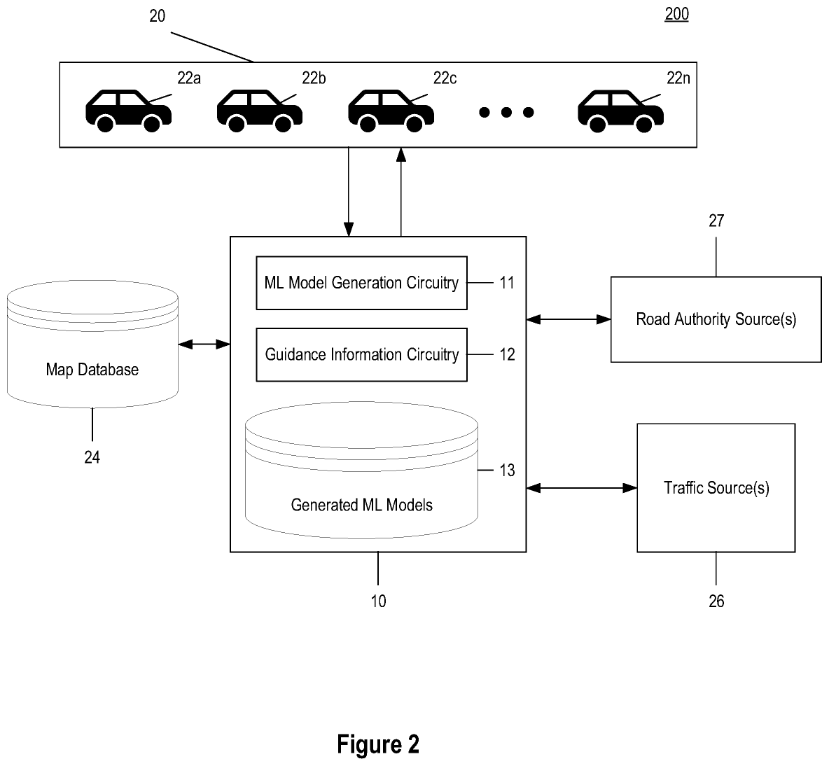

Regardless of the manner in which the apparatus is embodied, however, the apparatus 10 includes, is associated with, or is in communication with processing circuitry 15, memory 14, a communication interface 16, machine learning (ML) model generation circuitry 11, guidance information circuitry 12, and optionally a user interface 17 as shown in FIG. 1. In some embodiments, the processing circuitry (and/or co-processors or any other processors assisting or otherwise associated with the processing circuitry) can be in communication with the memory via a bus for passing information among components of the apparatus. The memory 14 can be non-transitory and can include, for example, one or more volatile and/or non-volatile memories. In other words, for example, the memory 14 may be an electronic storage device (for example, a computer readable storage medium) comprising gates configured to store data (for example, bits) that can be retrievable by a machine (for example, a computing device like the processing circuitry). The memory 14 can be configured to store information, data, content, applications, instructions, or the like for enabling the apparatus to carry out various functions in accordance with an example embodiment of the present disclosure. For example, the memory 14 can be configured to buffer input data for processing by the processing circuitry, and/or store one or more generated ML models 13, further described below in reference to FIG. 2. Additionally or alternatively, the memory 14 can be configured to store instructions for execution by the processing circuitry 15.

The processing circuitry 15 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 15 can include one or more processing cores configured to perform independently. A multi-core processor can enable multiprocessing within a single physical package. Additionally or alternatively, the processing circuitry 15 can include one or more processors configured in tandem via the bus to enable independent execution of instructions, pipelining and/or multithreading.

In an example embodiment, the processing circuitry 15 can be configured to execute instructions stored in the memory 14 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as user device(s) (e.g., mobile phones and/or the like), vehicle ADAS and/or navigation device(s), traffic source(s) 26 and/or road authority source(s) 27 and/or a map database 24 which, in one embodiment, stores data (e.g., map data, route data, etc.) generated and/or employed by the processing circuitry 12. Additionally or alternatively, the communication interface 16 can be configured to communicate in accordance with various wireless protocols including Global System for Mobile Communications (GSM), such as but not limited to Long Term Evolution (LTE). In this regard, the communication interface 16 can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

In some embodiments, the apparatus 10 may comprise additional circuitry for carrying out operations associated with generating one or more ML models and/or determining contextual guidance information. For example, the apparatus 10 may comprise ML model generation circuitry 11 and/or guidance information circuitry 12. The ML model generation circuitry 11 and guidance information circuitry 12 may be embodied by the processing circuitry 15 or by another processor that may, in turn, be embodied as described above in relation to the processing circuitry 15. The ML model generation circuitry 11 and the guidance information circuitry may each comprise one or more instructions and/or predefined functions for directing the processing circuitry 15 or another processor to carry out operations associated with the respective circuitry. In an embodiment, the ML model generation circuitry 11 may comprise one or more predefined functions and/or instructions to be executed by the processing circuitry 15 or another processor to generate one or more ML models, such as, for example, human cognitive models, behavior and/or context-based ML models, and/or the like. For example, the ML model generation circuitry 11 may comprise a ML model framework configured to train and generate one or more ML models based on received data, such as data received via communication interface 16.

In some embodiments, the guidance information circuitry 12 may comprise one or more predefined functions and/or instructions to be executed by the processing circuitry 15 or another processor to determine and/or generate contextual guidance information. For example, in some embodiments, the guidance information circuitry 12 may comprise one or more predefined rules (e.g., a rule set) to be applied to output of one or more ML models generated by the ML model generation circuitry 11 in order to determine contextual guidance information.

The apparatus 10 may also optionally include a user interface 17 that may, in turn, be in communication with the processing circuitry 15 to provide output to the user and, in some embodiments, to receive an indication of a user input. As such, the user interface 17 may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry 15 and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

Referring now to FIG. 2, an example system in which the apparatus 10 may operate in accordance with some embodiments described herein is depicted. As shown, and described above, the apparatus 10 includes ML model generation circuitry 11 and guidance information circuitry 12. The apparatus 10 may also comprise one or more generated ML models 13, such as behavior and/or context-based ML models generated by the ML model generation circuitry 11. The generated ML models 13 may be stored, for example, in memory 14.

The apparatus 10 may receive data (e.g., via communication interface 16) from one or more vehicles 22a-n of a plurality of vehicles 20. For example, the apparatus 10 may receive data from one or more navigation devices carried by or installed within a vehicle 22a-n, one or more vehicle sensors associated with a vehicle 22a-n, and/or one or more user devices associated with a user (e.g., driver/occupant of the vehicle).

The navigation device(s), user device(s) and/or vehicle sensor(s) may be carried by or installed within a vehicle 22a-n. Vehicle sensor(s) may include, for example, engine sensor(s) such as a throttle sensor that measures a position of a throttle of the engine or a position of an accelerator pedal, a brake sensor that measures a position of a braking mechanism or a brake pedal, a speed sensor that measures a speed of the engine or a speed of the vehicle wheels, and/or the like. Vehicle sensor(s) may also include a steering wheel angle sensor, a speedometer sensor, or a tachometer sensor. Additional vehicle sensor(s) may include one or more cameras, light detection and ranging (LIDAR) sensor(s), radar sensor(s), or ultrasonic sensor(s). In some embodiments, vehicle sensor(s) may be configured to determine road status such as the shape or turns of the road, the existence of speed bumps, the existence of potholes, the wetness of the road, or the existence or ice, snow, or slush. By way of example, the vehicle sensors may be any type of sensor. In certain embodiments, the vehicle sensors may include, for example, a global positioning sensor for gathering location data, a network detection sensor for detecting wireless signals or receivers for different short-range communications (e.g., Bluetooth, Wi-Fi, Li-Fi, near field communication (NFC), etc.), temporal information sensors, a camera/imaging sensor for gathering image data (e.g., the camera sensors may automatically capture emotions of drivers or eye movements, or environment inside or outside the vehicle), an audio recorder for gathering audio data, velocity sensors mounted on steering wheels of the vehicles, and the like. In one embodiment, the vehicle sensors may include steering wheel sensor, a driver seat pressure sensor, a brake pressure sensor, a heat sensor, a motion sensor, a laser sensor, a telematics sensor, or a combination thereof In another embodiment, the vehicle sensors may include light sensors, orientation sensors augmented with height sensor and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc.

Vehicle sensors about the perimeter of the vehicle may detect the relative distance of the vehicle from lane or roadways, the presence of other vehicles, pedestrians, traffic lights, potholes and any other objects, or a combination thereof In some embodiments, the vehicle sensors may detect weather data, traffic information, or a combination thereof In one example embodiment, the vehicle may include Global Positioning System (GPS) receivers to obtain geographic coordinates from satellites for determining current location, speed information and time associated with the vehicle. Further, the location can be determined by a triangulation system such as Assisted GPS (A-GPS), Cell of Origin, or other location extrapolation technologies. In another embodiment, the vehicle sensors may include Differential GPS (D-GPS), windshield wiping sensors, microphone sensors, shift sensor, pedal sensor, lever sensor, speed sensor, headlamp sensor, steering wheel sensor, or a combination thereof. These sensors provide mobility information about the vehicle, environmental conditions, and driver status information.

In some embodiments, a navigation device may be a specialized autonomous driving computer configured to report data (e.g., data from the vehicle sensor(s)) to the apparatus 10.

A navigation device may be a personal navigation device (PND), a portable navigation device smart phone, a mobile phone, a personal digital assistant (PDA), a tablet computer, a notebook computer, and/or any other mobile device or personal computer. Non-limiting embodiments of navigation devices may also include Radio Data System (RDS) devices, high-definition (HD) radio devices, mobile phone devices, or car Global Positioning System (GPS) navigation devices. As discussed further herein, the apparatus 10 may be configured to provide contextual guidance information to a vehicle 22a-n based on data received from the vehicle.

A user device may be a personal electronic device of a user, such as a mobile phone (e.g., smartphone), tablet, smart watch, or the like, including the accessories and peripherals of these devices, or any combination thereof. It is also contemplated that the user device can support any type of interface to the user (such as “wearable” circuitry, etc.). In one embodiment, the user device may be a vehicle, a mobile device (e.g., smartphone), and/or a combination of the two. The user device may include various applications, sensors, firmware, software, etc., for various tasks and purposes. By way of example, the applications may be any type of application that is executable at the user device, such as, location-based service applications, content provisioning services, camera/imaging applications, mapping applications, navigation applications, media player applications, social networking applications, calendar applications, and the like.

Further, these devices may be utilized in various settings and places, for example, at home, at the office, in/on a vehicle, and the like. For example, users are increasingly utilizing their user devices in cars for various functionalities, e.g., for navigation information, traffic conditions, information, entertainment, vehicle speed, engine revolutions per minute (RPM), fuel consumption, temperatures inside/outside the vehicle, vehicle diagnostics information, and the like. Certain user devices (e.g., smart watch, fitness band) may also be utilized to monitor certain conditions of the user, such as heart rate, blood pressure, and/or the like.

The apparatus 10 may additionally be in communication with and receive data from one or more traffic sources 26 and/or road authority source(s) 27. For example, a traffic source 26 may be a computing device or the like that is associated with a traffic regulatory organization or similar body responsible for monitoring and/or reporting traffic conditions (e.g., congestion, wait times, weather, etc.) of a predefined area. For example, data received from a traffic source 26 may comprise data associated with a congestion level for an area/region or the like, estimated wait or delay time(s) for an area/region, current weather conditions for an area/region, and/or the like.

A road authority source 27 may be a computing device or the like that is associated with an authoritative organization (e.g., a police department) or similar body responsible for monitoring and/or reporting conditions associated with roadways and their surrounding regions. For example, data received from a road authority source 27 may comprise data associated with conditions a roadway may be experiencing, such as lane or road closures, detours, traffic accidents, or the like. In some embodiments, data received from a road authority source 27 may further comprise crime data for a region, such as historical and/or current crime data.

The apparatus 10 may additionally be in communication with a map database 24. The map database 24 may include node data, road segment data or link data, point of interest (POI) data, traffic data or the like. The map database may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database. As noted above, the map database accessed by an apparatus 10 of an example embodiment includes information regarding one or more map objects including information regarding the type of map object and the location of the map object.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile devices onboard the vehicles, as they travel the roads throughout a region.

The map database 24 may be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by a mobile device onboard the vehicle, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

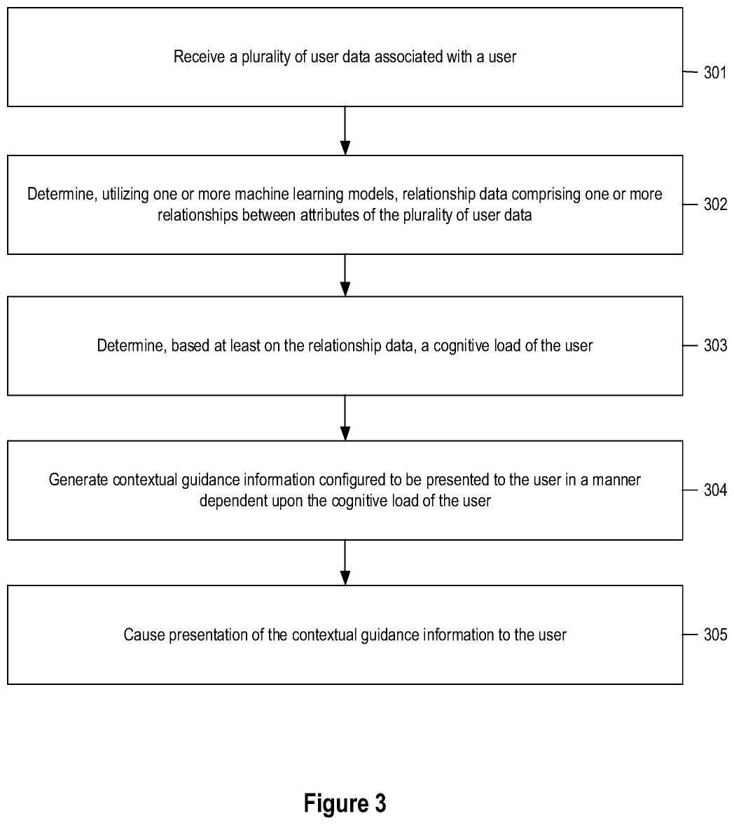

Referring now to FIG. 3, the operations performed, such as by the apparatus 10 of FIG. 1, in order to generate and provide contextual guidance information are depicted. As shown in block 301, the apparatus includes means, such as the processing circuitry 15, memory 14, the communication interface 16, and/or the like, for receiving a plurality of user data associated with a user. For example, the user may be a driver and/or passenger of a vehicle 22a-n.

The plurality of user data may serve to define a current context of the user. For example, as described above, the plurality of user data may include sensor data, such as readings from vehicle sensor(s), including but not limited to a current speed of the vehicle, a current engine revolutions per minute (RPM) reading, yaw rate or velocity, a current gear in which the vehicle is operating, engine throttle level, steering wheel angle, accelerator/brake pedal position, and/or the like. Further, such user data received from vehicle sensor(s) may also include indications of whether other vehicles are surrounding the vehicle, distance value(s) representing how close surrounding vehicles are to the vehicle (e.g., if the vehicle is following a vehicle closely and/or being followed closely by another vehicle), how many passengers are within the vehicle, whether the driver's eyes are on the road (e.g., determined by a vehicle sensor such as a camera or the like), a noise level within the cabin of the vehicle, whether one or more windows of the vehicle are open, a current level of a blower providing air conditioning and/or heat within the vehicle, a current weight of the vehicle (e.g., if the vehicle is carrying heavy cargo) and/or other similar data.

The plurality of user data may also comprise data received from one or more navigation devices and/or user devices. For example, such data may include a current location of the vehicle, a current temperature inside and/or outside of the vehicle, one or more current health conditions of the user (e.g., heart rate or similar measurement taken by a smart watch), whether the user is presently engaged in a conversation (e.g., on a phone call), whether the user is presently interacting with the user device and/or navigation device, road characteristics such as sharp maneuvers and/or the like, and/or other similar data.

The plurality of user data may also comprise traffic data associated with the present location of the user. Such user data may be received from one or more traffic sources 26 as described above. For example, traffic data may indicate a traffic congestion level the user is experiencing, an estimated length and/or delay time of the traffic congestion, current weather conditions associated with the current location of the vehicle (e.g., low visibility/fog, rain, ice, etc.), and/or other similar data.

The plurality of user data may also comprise data received from one or more road authority sources 27 as described above. Such data may include statistical data associated with the present location of the user, such as crime data. Crime data may be associated with a current ongoing situation, such as a high-speed chase in the area, one or more road and/or lane closures, or the like. Crime data may also comprise historical crime data indicative of a historic crime level of the region in which the vehicle is located. For example, the driver's cognitive load may be increased while traversing a high-crime area such that the user is more focused and/or on high alert.

As shown in block 302, the apparatus includes means, such as the processing circuitry 15, memory 14, and/or the like, for determining, utilizing one or more machine learning models, relationship data comprising one or more relationships between attributes of the plurality of user data. In this regard, the plurality of user data may be provided as input to one or more ML models 13. The relationship data between different attributes of user data may be identify those relationships that are indicative, at least in combination, of the current context in which the user is operating and/or the current cognitive load of the user, as described below.

For example, as described above, the apparatus 10 may store (e.g., in memory 14) one or more machine learning models 13 to be utilized in determining contextual guidance information. In this regard, one or more generated ML models may have been previously trained using a plurality of data in the form of a training dataset such that the one or more ML models 13, as trained, are configured to determine relationship data for a plurality of attributes included in user data that is provided as input to the one or more ML models.

A training dataset may include a plurality of data received from a plurality of vehicles, such as the plurality of vehicles 20. Such data may include user data as described above, such as data from navigation devices, vehicle sensors, user devices, and/or the like. The data may be collected over a period of time for a plurality of vehicles during traversal of a plurality of regions/areas. Such data may include historical user behavioral data, historical user context data, and/or other similar data.

The training dataset for one or more ML models may further include historical map data (e.g., data from map database 24 regarding terrain and/or other features of a plurality of roadways), external road authority source data, and/or external traffic source data, such as data collected from one or more road authority sources 27 and traffic sources 26 as described above.

In accordance with an example embodiment, the apparatus 10 also includes means, such as the processing circuitry 12, the memory 14, the ML model generation circuitry 11, or the like, configured to train at least one machine learning model utilizing the training dataset. In this regard, the at least one machine learning model may be trained such that the machine learning model, as trained, is configured to determine relationship data for a plurality of attributes included in user data that is provided as input to the at least one ML model.

The apparatus 10, such as the processing circuitry 12, may train any of a variety of machine learning models. Some examples of machine learning models that may be trained include behavior and context-based ML models, and/or the like.

For example, the at least one machine learning model may be constructed and trained to determine one or more correlations (e.g., relationship data) within data input to the machine learning model. For example, similarities between one or more attributes included in the input data associated with a user may be determined. In this regard, any number of measures may be considered, such as correlations between data from vehicle sensor(s), user/navigation devices, traffic and/or road authority sources, etc. The relationships or correlations between data input may be those that are indicative, at least in combination, of the current context in which the user is operating and/or the current cognitive load of the user. For example, a vehicle slowing or a vehicle having its lights activated may not, by themselves, provide significant contextual information, but the combination of a vehicle slowing, the vehicle having its lights activated and the vehicle having its windshield wipers activated may be indicative of a significant storm and an increased cognitive load.

As shown in block 303, the apparatus includes means, such as the processing circuitry 15, memory 14, the communication interface 16, and/or the like, for determining, based at least on the relationship data, a cognitive load of the user. In this regard, the relationship data that is output from the one or more ML models 13 may be processed in order to determine a cognitive load of the user and, in turn, generate contextual guidance information as described further below.

In some embodiments, determining a cognitive load of the user may further include an information gain calculation. In this regard, the apparatus 10 includes means, such as the processing circuitry 15, memory 14, guidance information circuitry 12, and/or the like, for calculating information gain for the one or more relationships between attributes of the plurality of user data. In one embodiment, the apparatus 10 may cause an application of a feature selection mechanism to classify the attributes and relationships between attributes of the relationship data deemed useful for determining contextual guidance information. The feature selection may include algorithms, such as those based on information gain, to determine whether each attribute and/or relationship is useful for determining contextual guidance information. By way of example, these attributes/relationships may be selected based on their potential to affect/improve the contextual guidance information that is provided to a user in a particular context.

In some embodiments, determining a cognitive load of the user may further include utilizing one more predefined rules of a rule set on the relationship data. In this regard, the apparatus 10 includes means, such as the processing circuitry 15, memory 14, guidance information circuitry 12, and/or the like, for applying one or more predefined rules to the relationship data.

For example, predefined rules may be applied to attributes and their relationships in order to generate contextual guidance information. In some embodiments, the one or more predefined rules may be associated with a human cognitive model. In this regard, the predefined rules may be utilized in order to make output from the ML models more attributable to the human domain. Alternatively, the predefined rules may be hard-coded rules. An example rule may be that if a car window is open, to present guidance information visually (e.g., via a user interface) rather than audibly (in this regard, the user may have a difficult time hearing audible guidance information due to the window being open).

In some embodiments, a cognitive load of the user may be represented by a value, such as a scaled value (e.g., a value between 0 and 1). For example, a value closer to one (1) may indicate that the user is experiencing a high cognitive load. Likewise, a value closer to zero (0) may indicate that the user is experiencing a low cognitive load. In other embodiments, the cognitive load of a user may be represented by a set of values indicative of an amount of cognitive resources a user is utilizing for a particular time. In this regard, if the amount of cognitive resources the user is utilizing affects the amount of cognitive resources needed for a primary task such as driving, this may indicate a high cognitive load of the user.

As shown in block 304, the apparatus includes means, such as the processing circuitry 15, memory 14, the guidance information circuitry 12, and/or the like, for generating contextual guidance information configured to be presented to the user in a manner dependent upon the cognitive load of the user. For example, the contextual guidance information may be generated through use of the ML models described above (e.g., behavior and context-based ML models), the predefined rules as described above, as well as through use of a human cognitive model. In this regard, a human cognitive model (e.g., stored in memory 14) may be used to evaluate cognitive load data determined above through the ML model(s) and predefined rules. The human cognitive model may evaluate the cognitive load data to determine whether the data is valid within a human domain and/or apply necessary changes to the data in order to generate accurate contextual guidance information.

As one example, the plurality of user data collected and subsequent relationship data determined by the one or more ML models may indicate that the user is having difficulty controlling the vehicle (e.g., hydroplaning) due to heavy rainfall and low visibility. The user is additionally focused on the road and is not in an ideal position to glance at a visual display of guidance information. In this regard, the contextual guidance information determined for the user may include an audible instruction directing the user to “turn left at the gas station ahead,” rather than, for example, a visual instruction directing the user to “turn left at Main St. in 200 feet.” In this regard, the contextual guidance information may be configured such that it may be easier for the user, given their cognitive load, to interpret the audible instruction and to visually locate a large target such as the gas station rather than having to glance to a user interface to read the instruction and subsequently attempt to locate a street sign for Main St. as well as estimate 200 feet ahead of the vehicle under the low-visibility and heavy rainfall conditions.

As another example, the plurality of user data collected and subsequent relationship data determined by the one or more ML models may indicate that the user is presently having a conversation via phone while also transporting several other passengers who are also having their own conversations within the vehicle. In this regard, the contextual guidance information determined for the user may include a visually displayed instruction (e.g., at a user interface) directing the user to “take the next exit,” rather than an audible instruction stating “in 1.2 miles, take exit 340b.” In this regard, the contextual guidance information may be configured such that it may currently be easier for the user to interpret the visual instruction rather than having to listen for an audible instruction over their phone conversation and conversations within the vehicle and additionally to remember the details of the mileage and exit number given the user's cognitive load.

As described above, contextual guidance information may be configured to be presented to a user in a particular way (e.g., visually/audibly) and in a particular manner (e.g., simpler text/voice commands). As yet another example, contextual guidance information may also be configured to be presented to a user such that the timing of instructions are in accordance with the user's cognitive load. For example, the contextual guidance information may be based on road characteristic data received, e.g., from one or more vehicle sensor(s) as described above. In this regard, at a time in which a user is making a sharp maneuver with the vehicle, the contextual guidance information may be configured to postpone any instructions/commands to the driver until the maneuver is completed. In this regard, the user will not take on an increased cognitive load by having to interpret an instruction while sharply maneuvering the vehicle.

As shown in block 305, the apparatus includes means, such as the processing circuitry 15, memory 14, the communication interface 16, and/or the like, for causing presentation of the contextual guidance information to the user.

As described above, the contextual guidance information may be presented to the user in a manner dependent upon the user's cognitive load. For example, the contextual guidance information may be presented visually (e.g., at a user interface of a user device, navigation device, and/or the like), and/or audibly (e.g., through vehicle and/or user device speakers) depending upon the cognitive load of the user. In some embodiments, as described above, the contextual guidance information may direct the user to landmarks (e.g., a gas station in the above example) rather than measured distances and/or road signs in instances in which the user may be experiencing a higher cognitive load.

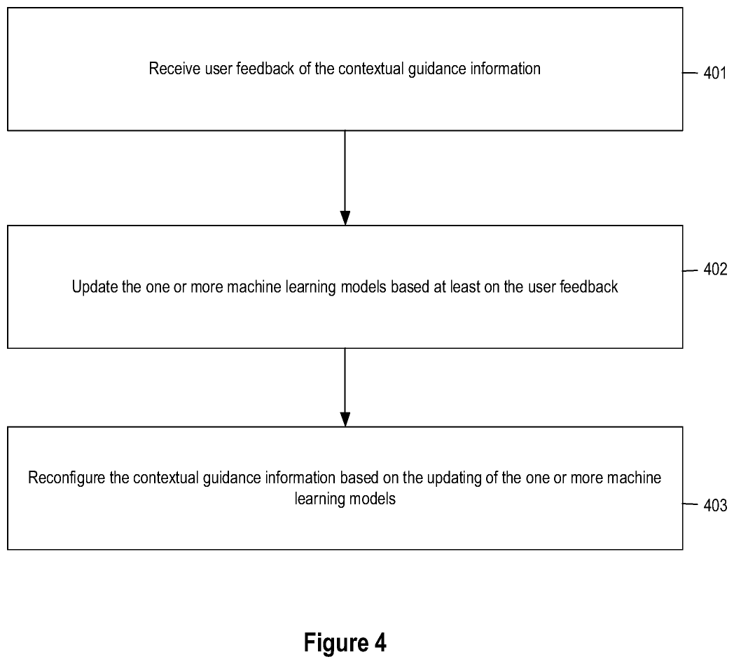

Referring now to FIG. 4, the operations performed, such as by the apparatus 10 of FIG. 1, in order to reconfigure contextual guidance information based on user feedback are depicted.

As shown in block 401, the apparatus includes means, such as the processing circuitry 15, memory 14, the communication interface 16, and/or the like, for receiving user feedback of the contextual guidance information.

The user feedback may be received, in some embodiments, in response to a visual and/or audible prompt provided by the apparatus 10 to the user (e.g., at a user interface and/or through audio means such as speakers of a user device and/or vehicle). For example, after determining a cognitive load of a user and presenting contextual guidance information in a manner dependent upon the cognitive load, the apparatus 10 may cause presentation of a feedback prompt asking the user if they prefer to continue receiving contextual guidance information in the manner that it is being presented. In this regard, the apparatus includes means, such as the processing circuitry 15, memory 14, the communication interface 16, and/or the like, for causing presentation of a feedback prompt associated with the contextual guidance information. As one non-limiting example, a feedback prompt may be audibly presented to a user that asks the user if they wish to continue receiving guidance information in an audible fashion after providing an audible instruction based on contextual guidance information. In this regard, the apparatus 10 may receive user feedback in an audible form of a “yes” or “no” answer from the user.

In some embodiments, a prompt may not be needed in order to receive user feedback of contextual guidance information. For example, the user feedback may be detected by user data received after contextual guidance information is provided to the user. For example, after providing one or more instructions of contextual guidance information to a user in a manner dependent upon the user's cognitive load, the apparatus 10 may continue to receive user data associated with the user (e.g., as described above in block 301 of FIG. 3). In this regard, actions of the user after having received contextual guidance information may indicate whether the user adheres to the contextual guidance information or fails to obey instructions provided by the contextual guidance information.

As another example, the user feedback may be collected indirectly. In this regard, during a particular context, a user may receive contextual guidance information. At a later time in which the context reoccurs, the user's cognitive load may be determined again by collecting user data (e.g., sensor data as described above) to measure any improvements (decreases) in cognitive load. Based on the redetermination of the cognitive load and updated user data, the ML model(s) may be remodeled/retrained.

As shown in block 402, the apparatus includes means, such as the processing circuitry 15, memory 14, the communication interface 16, and/or the like, for updating the one or more machine learning models based at least on the user feedback.

In this regard, based on the user feedback indicating user approval or disapproval of the contextual guidance information and/or whether the user obeys or fails to adhere to the contextual guidance information, one or more ML models may be updated or re-trained with the addition of the user feedback. In this regard, the ML model(s) may be retrained and improved such that the output of the ML model(s) (e.g., relationship data) may more accurately represent relationships between attributes of user data input to the ML model(s).

As shown in block 403, the apparatus includes means, such as the processing circuitry 15, memory 14, the communication interface 16, and/or the like, for reconfiguring the contextual guidance information based on the updating of the one or more machine learning models.

In this regard, after receiving user feedback and re-training the ML model(s) as described above, contextual guidance information may be re-configured and presented to the user in a manner more suitable to the user in the given context. For example, a user not adhering to an instruction of contextual guidance information directing the user to “take exit 340b” (e.g., the user missing the exit), contextual guidance information may be reconfigured such that the next instruction directs the user to “take the next exit,” rather than directing the user to a specific exit number.

As described above, a method, apparatus and computer program product are provided in accordance with an example embodiment for generating and providing guidance information based on a current cognitive load of a user. By utilizing one or more machine learning models, such as behavior and context-based machine learning models, with data indicative of a current context of a user (e.g., vehicle sensor, user device and/or navigation device data) as well as data from additional sources such as a map database, traffic source(s), and/or road authority source(s), optimized and context-appropriate guidance information may be generated and provided to a user, thereby leading to increased passenger safety, reduced network load by way of an increased adherence to guidance information, and an overall improved passenger experience.

FIGS. 3-4 illustrate flowcharts depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory storing computer program code, the at least one memory and the computer program code configured to, with the processor, cause the apparatus to at least:
receive a plurality of user data associated with a user;
determine, utilizing one or more machine learning models, relationship data comprising one or more relationships between attributes of the plurality of user data;
determine, based at least on the relationship data, a cognitive load of the user;
generate contextual guidance information configured to be presented to the user in a manner dependent upon the cognitive load of the user; and
cause presentation of the contextual guidance information to the user.

2. The apparatus according to claim 1, wherein the at least one memory and the computer program code are further configured to, with the processor, cause the apparatus to:
receive user feedback of the contextual guidance information; and
update the one or more machine learning models based at least on the user feedback.

3. The apparatus according to claim 2, wherein the at least one memory and the computer program code that are further configured to update the one or more machine learning models are further configured to, with the processor, cause the apparatus to:
reconfigure the contextual guidance information based on the updating of the one or more machine learning models.

4. The apparatus according to claim 1, wherein the at least one memory and the computer program code configured to determine the cognitive load of the user are further configured to, with the processor, cause the apparatus to:
apply one or more predefined rules to the relationship data, wherein the one or more predefined rules are associated with a human cognitive model.

5. The apparatus according to claim 1, wherein the at least one memory and the computer program code configured to determine the cognitive load of the user are further configured to, with the processor, cause the apparatus to:
calculate information gain for the one or more relationships between attributes of the plurality of user data.

6. The apparatus according to claim 1, wherein the plurality of user data comprises data associated with one or more user devices associated with the user and sensor data associated with one or more sensors of a vehicle associated with the user.

7. The apparatus according to claim 1, wherein at least one of the one or more machine learning models are trained in accordance with one or more of: historical map data, historical user behavioral data, historical user context data, external road authority source data, or external traffic source data.

8. A method comprising:
receiving a plurality of user data associated with a user;
determining, utilizing one or more machine learning models, relationship data comprising one or more relationships between attributes of the plurality of user data;
determining, based at least on the relationship data, a cognitive load of the user;
generating contextual guidance information configured to be presented to the user in a manner dependent upon the cognitive load of the user; and
causing presentation of the contextual guidance information to the user.

9. The method according to claim 8, further comprising:
receiving user feedback of the contextual guidance information; and
updating the one or more machine learning models based at least on the user feedback.

10. The method according to claim 9, wherein updating the one or more machine learning models further comprises:
reconfiguring the contextual guidance information based on the updating of the one or more machine learning models.

11. The method according to claim 8, wherein determining the cognitive load of the user further comprises:
applying one or more predefined rules to the relationship data, wherein the one or more predefined rules are associated with a human cognitive model.

12. The method according to claim 8, wherein the determining the cognitive load of the user further comprises:
calculating information gain for the one or more relationships between attributes of the plurality of user data.

13. The method according to claim 8, wherein the plurality of user data comprises data associated with one or more user devices associated with the user and sensor data associated with one or more sensors of a vehicle associated with the user.

14. The method according to claim 8, wherein at least one of the one or more machine learning models are trained in accordance with one or more of: historical map data, historical user behavioral data, historical user context data, external road authority source data, or external traffic source data.

15. A computer program product including a non-transitory computer readable medium having program code portions stored thereon with the program code portions being configured, upon execution, to:
receive a plurality of user data associated with a user;
determine, utilizing one or more machine learning models, relationship data comprising one or more relationships between attributes of the plurality of user data;
determine, based at least on the relationship data, a cognitive load of the user;
generate contextual guidance information configured to be presented to the user in a manner dependent upon the cognitive load of the user; and
cause presentation of the contextual guidance information to the user.

16. The computer program product according to claim 15, wherein the program code portions are further configured to:
receive user feedback of the contextual guidance information; and
update the one or more machine learning models based at least on the user feedback.

17. The computer program product according to claim 16, wherein the program code portions that are further configured to update the one or more machine learning models are further configured to, with the processor, cause the apparatus to:
reconfigure the contextual guidance information based on the updating of the one or more machine learning models.

18. The computer program product according to claim 15, wherein the program code portions that are configured to determine the cognitive load of the user are further configured to, with the processor, cause the apparatus to:
apply one or more predefined rules to the relationship data, wherein the one or more predefined rules are associated with a human cognitive model.

19. The computer program product according to claim 15, wherein the program code portions that are configured to determine the cognitive load of the user are further configured to, with the processor, cause the apparatus to:
calculate information gain for the one or more relationships between attributes of the plurality of user data.

20. The computer program product according to claim 15, wherein at least one of the one or more machine learning models are trained in accordance with one or more of: historical map data, historical user behavioral data, historical user context data, external road authority source data, or external traffic source data.
